(19) United States
(12) Patent Application Publication
(10) Pub. No.: US 2024/0373197 A1
(43) Pub. Date: Nov. 7, 2024

(54) MESSAGE DISTRIBUTION SYSTEM, MESSAGE DISTRIBUTION METHOD, AND NON-TRANSITORY COMPUTER READABLE MEDIUM

(71) Applicant: NEC Corporation, Minato-ku, Tokyo (JP)

(72) Inventor: Tomohiro INOUE, Tokyo (JP)

(73) Assignee: NEC Corporation, Minato-ku, Tokyo (JP)

(21) Appl. No.: 18/285,698

(22) PCT Filed: Apr. 13, 2021
(86) PCT No.: PCT/JP2021/015284

§ 371 Date: Oct. 5, 2023

(51) Int. Cl. H04W 4/14; G06F 16/955

(52) U.S. Cl. CPC H04W 4/14; G06F 16/955

(57) ABSTRACT

A message distribution system includes a distribution request reception unit, a translation unit, a distribution message generation unit, and a distribution unit. The distribution request reception unit receives a distribution request including a reception message body and a distribution destination telephone number including a country code.

The translation unit translate the reception message body into a language corresponding to the country code, to thereby generate a first translation message body. The distribution message generation unit generates a distribution message including the first translation message body. The distribution unit distributes the distribution message to a mobile terminal corresponding to the distribution destination telephone number by means of an SMS.

### TECHNICAL FIELD

The present invention relates to a message distribution system, a message distribution method, and a non-transitory computer readable medium.

### BACKGROUND ART

Patent Literature 1 discloses an information distribution system which is installed, for example, at a railway station and which distributes information about arrival and departure times of trains. The information distribution system includes a display for distributing information. The display displays a telephone number for changing the language used for information distribution. When a user dials the telephone number on the user's own mobile phone, the information distribution system distributes information in accordance with the language corresponding to the country code of the telephone number registered in the SIM card installed in the user's mobile phone. Alternatively, when a user transmits an SMS message to the telephone number by the user's own mobile phone, the information distribution system distributes information in accordance with the language corresponding to the body part of the SMS message. Patent Literature 1 further discloses a form in which when a user dials the telephone number on the user's own mobile phone, a plurality of language candidates used for information distribution are displayed on the display and the user selects one of the candidates.

Patent Literature 2 discloses a data translation apparatus which is interposed between a plurality of user terminals and which attaches, to an email transmitted from a user terminal to another user terminal, a translation of the email body part. The data translation apparatus includes a database in which an email address is associated with a language used by a user using the email address and stored. When the used language corresponding to the email address of a transmission source is different from the used language corresponding to the email address of a destination, the data translation apparatus translates the email body part into the used language corresponding to the email address of the destination. Further, the data translation apparatus attaches the translation to the email and transmits it to a user terminal of the destination.

### CITATION LIST

### Patent Literature

Patent Literature 1: Published Japanese Translation of PCT International Publication for Patent Application, No. 2014-518472
Patent Literature 2: Japanese Unexamined Patent Application Publication No. 2011-141750

### SUMMARY OF INVENTION

### Technical Problem

Incidentally, when a message is distributed by means of an SMS to a plurality of users who use languages different from each other, the message translated into all the languages has to be distributed to all the users by means of an SMS so that all the users can understand the message, which is troublesome.

Further, by knowing all the languages used by respective users in advance, a message can be translated into the languages suitable for the respective users and then distributed by means of an SMS. However, this is still troublesome.

Since the technologies disclosed in Patent Literature 1 and Patent Literature 2 are not related to the distribution by means of an SMS, the above problems cannot be solved.

An object of the present disclosure is to provide a technology for translating a message into a suitable language and then distributing it by means of an SMS.

### Solution to Problem

The present disclosure provides a message distribution system including: a distribution request reception unit configured to receive a distribution request including a reception message body and a distribution destination telephone number including a country code; a translation unit configured to translate the reception message body into a language corresponding to the country code, to thereby generate a first translation message body; a distribution message generation unit configured to generate a distribution message including the first translation message body; and a distribution unit configured to distribute the distribution message to a mobile terminal corresponding to the distribution destination telephone number by means of an SMS.

The present disclosure provides a message distribution method including: a distribution request reception step of receiving a distribution request including a reception message body and a distribution destination telephone number including a country code; a translation step of translating the reception message body into a language corresponding to the country code, to thereby generate a first translation message body; a distribution message generation step of generating a distribution message including the first translation message body; and a distribution step of distributing the distribution message to a mobile terminal corresponding to the distribution destination telephone number by means of an SMS.

The present disclosure provides a non-transitory computer readable medium storing a program for causing a computer to execute: a distribution request reception step of receiving a distribution request including a reception message body and a distribution destination telephone number including a country code; a translation step of translating the reception message body into a language corresponding to the country code, to thereby generate a first translation message body; a distribution message generation step of generating a distribution message including the first translation message body; and a distribution step of distributing the distribution message to a mobile terminal corresponding to the distribution destination telephone number by means of an SMS.

### Advantageous Effects of Invention

According to the present invention, it is possible to translate a message into a suitable language and then distribute it by means of an SMS.

### BRIEF DESCRIPTION OF DRAWINGS

FIG. 1 is a schematic diagram of a message distribution system (first example embodiment);

FIG. 2 is a schematic diagram of a distribution system (second example embodiment);

FIG. 3 is a functional block diagram of a message distribution server (second example embodiment);

FIG. 4 is a data structure diagram of a task management DB (second example embodiment);

FIG. 5 is a data structure diagram of a designated translation language DB (second example embodiment);

FIG. 6 is a control flow of the message distribution server (second example embodiment);

FIG. 7 is a display example of a display of a business entity terminal (second example embodiment);

FIG. 8 is a display example of a display of a mobile terminal when a distribution message is distributed to the mobile terminal (second example embodiment); and

FIG. 9 is a display example of a display of a mobile terminal when a request for a retranslation is made from the mobile terminal (second example embodiment).

### EXAMPLE EMBODIMENT

### First Example Embodiment

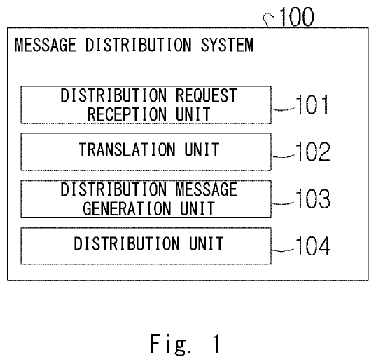

A first example embodiment will be described below with reference to FIG. 1. FIG. 1 is a schematic diagram of a message distribution system.

As shown in FIG. 1, a message distribution system 100 includes a distribution request reception unit 101, a translation unit 102, a distribution message generation unit 103, and a distribution unit 104.

The distribution request reception unit 101 receives a distribution request including a reception message body and a distribution destination telephone number including a country code.

The translation unit 102 translates the reception message body into a language corresponding to the country code, to thereby generate a first translation message body by.

The distribution message generation unit 103 generates a distribution message including the first translation message body.

The distribution unit 104 distributes the distribution message to a mobile terminal corresponding to the distribution destination telephone number by means of an SMS.

According to the above configuration, it is possible to translate a message into a suitable language and then distribute it by means of an SMS.

### Second Example Embodiment

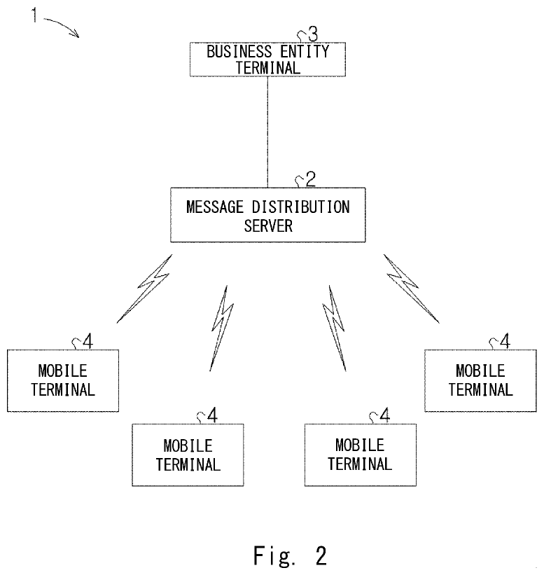

Next, a second example embodiment will be described with reference to FIGS. 2 to 9. FIG. 2 shows a schematic diagram of a distribution system.

As shown in FIG. 2, a distribution system 1 includes a message distribution server 2, a business entity terminal 3, and a plurality of mobile terminals 4. The message distribution server 2 is a specific example of a message distribution system.

The message distribution server 2 executes an SMS distribution to the plurality of mobile terminals 4 in response to a request from the business entity terminal 3.

The business entity terminal 3 is, for example, a terminal installed in an aviation business entity, a manufacturing business entity, or other business entities. The business entity terminal 3 includes input means such as a keyboard and a mouse, output means such as a display, and communication means for communicating with the message distribution server 2. In this example embodiment, the business entity terminal 3 is a terminal installed in an aviation business entity as an example.

The mobile terminal 4 is a terminal carried by a user who uses a service of a business entity where the business entity terminal 3 is installed. The mobile terminal 4 includes input means such as a touch panel, output means such as a display, communication means for communicating with the message distribution server 2 via the Internet, and communication means for enabling connection with a telephone network. The communication means achieves SMS distribution from the message distribution server 2 to the mobile terminal 4.

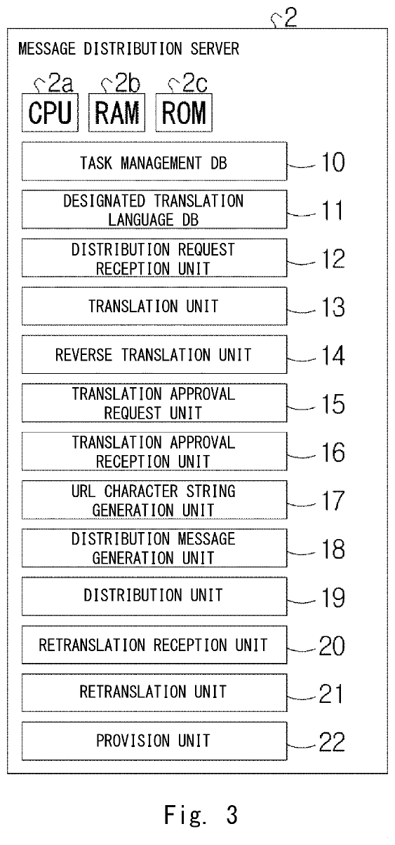

FIG. 3 shows a functional block diagram of the message distribution server 2.

As shown in FIG. 3, the message distribution server 2 according to this example embodiment is implemented by a single apparatus that performs a plurality of information processes by itself. Alternatively, however, the message distribution server 2 may be configured to perform a plurality of information processes by distributed processing by a plurality of apparatuses. That is, the message distribution server 2 may be implemented by a plurality of apparatuses. Further, a plurality of apparatuses composing the message distribution server 2 may be operated by business entities different from each other.

As shown in FIG. 3, the message distribution server 2 includes a Central Processing Unit (CPU) 2a serving as a central processing unit, a readable/writable Random Access Memory (RAM) 2b, and a read-only Read Only Memory (ROM) 2c. The message distribution server 2 further includes a task management DB 10 and a designated translation language DB 11. Further, the CPU 2a loads a control program stored in the ROM 2c and executes the loaded program, whereby the control program causes hardware such as the CPU 2a to function as various functional units.

The various functional units include a distribution request reception unit 12, a translation unit 13, a reverse translation unit 14, a translation approval request unit 15, a translation approval reception unit 16, a URL character string generation unit 17, a distribution message generation unit 18, a distribution unit 19, a retranslation reception unit 20, a retranslation unit 21, and a provision unit 22.

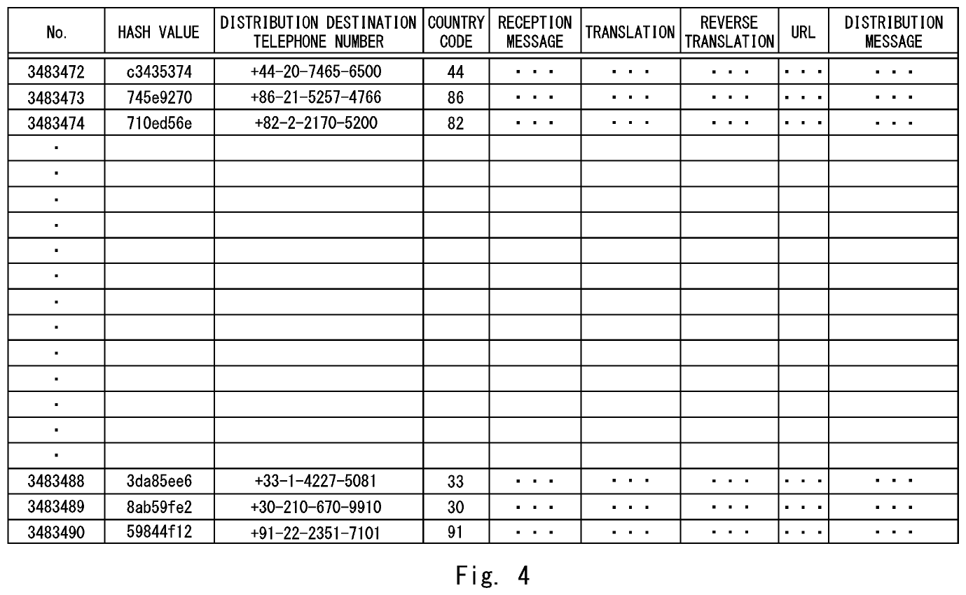

FIG. 4 shows a data structure of the task management DB 10. The task management DB 10 is a database for managing distribution requests received from the business entity terminal 3. The task management DB 10 associates a distribution request identification number (No.), a hash value of the distribution request identification number (hash value), a distribution destination telephone number, a country code, a reception message, a translation (translation), a reverse translation (reverse translation), a URL character string (URL), and a distribution message with each other and stores them.

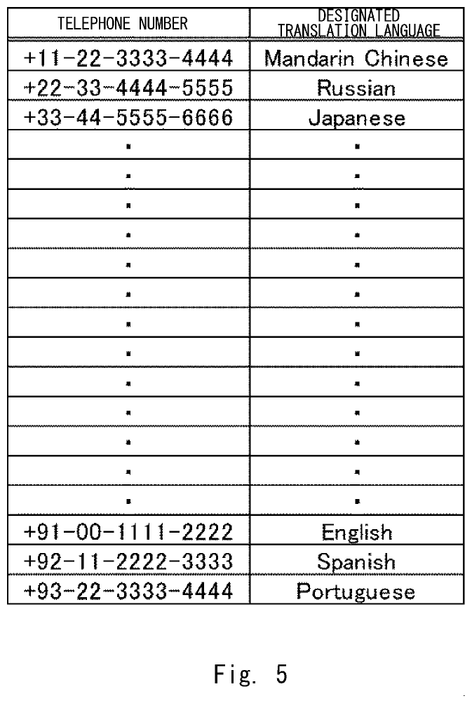

FIG. 5 shows a data structure of the designated translation language DB 11. The designated translation language DB 11 is a specific example of a designated translation language storage unit. As shown in FIG. 5, the designated translation language DB 11 associates a distribution destination telephone number (telephone number) with a designated translation language and stores them.

Referring back to FIG. 3, the distribution request reception unit 12 receives a distribution request from the business entity terminal 3. The distribution request includes a reception message body, which is a message the business entity terminal 3 wants to distribute to the mobile terminal 4, and a distribution destination telephone number, which is a telephone number of the mobile terminal 4. In this example embodiment, the distribution destination telephone number includes a country code and a national number. The country code is a number uniquely defined for each country. For example, when an international call is made from outside the United States to a mobile phone (the national number is 888-999-0000) in the United States, +1-888-999-0000 is dialed. In this case, “+1” corresponds to the country code and “888-999-0000” corresponds to the national number. The distribution request reception unit 12 registers the distribution request received from the business entity terminal 3 in the task management DB 10 shown in FIG. 4. Specifically, as shown in FIG. 4, the distribution request reception unit 12 writes the distribution destination telephone number of the distribution request in the “distribution destination telephone number” of the task management DB 10, extracts the country code from the distribution destination telephone number, writes it in the “country code” of the task management DB 10, and writes the reception message body in the “reception message” of the task management DB 10. Further, the distribution request reception unit 12 generates a hash value of the distribution request identification number and writes it in the “hash value” of the task management DB 10.

The translation unit 13 translates the reception message body of the distribution request into a language corresponding to the country code. Specifically, the translation unit 13 translates the reception message body written in the “reception message” of the task management DB 10 shown in FIG. 4 in a language uniquely defined based on the corresponding country code, and writes this translation in the “translation” of the task management DB 10. This translation is a specific example of a first translation message body. Note that a country-by-country language DB describing a corresponding relation between a country code and the language corresponding to the country code is prepared in advance, and thus the translation unit 13 may obtain the language corresponding to the country code by referring to the country-by-country language DB.

The reverse translation unit 14 reverse-translates the translation generated by the translation unit 13 into the language of the reception message body. Specifically, the reverse translation unit 14 translates the translation written in the “translation” of the task management DB 10 shown in FIG. 4 in the language of the reception message body, and writes this translation (hereinafter referred to as a reverse translation) in the “reverse translation” of the task management DB 10. The reverse translation is a specific example of a third translation message body. Note that the reverse translation unit 14 may acquire the language of the reception message body based on the reception message body itself.

The translation approval request unit 15 transmits the reverse translation and the translation approval request to a distribution request source so that the distribution request source can confirm the validity of the translation by the translation unit 13.

The translation approval reception unit 16 receives a translation approval from the distribution request source.

The URL character string generation unit 17 generates a URL character string for accessing the message distribution server 2 when a user of the mobile terminal 4 cannot understand the message distributed by means of an SMS. The URL character string includes a query character string for specifying a distribution request corresponding to the mobile terminal 4. In this example embodiment, a hash value of the distribution request identification number written in the “hash value” of the task management DB 10 shown in FIG. 4 is used as the query character string. The URL character string generation unit 17 writes the generated URL character string in the “URL” of the task management DB 10 shown in FIG. 4.

Note that, in this example embodiment, although the hash value of the distribution request identification number is used as the query character string for specifying the distribution request corresponding to the mobile terminal 4, a query character string of any type by which the distribution request can be uniquely specified can be used. For example, a query character string including the time when the message distribution server 2 received the distribution request and the distribution destination telephone number can be used. Further, a random token is generated for each distribution request, the generated token is associated with the corresponding distribution request and registered in the task management DB 10, and then the token is employed as a query character string, whereby it is possible to reduce the risk of information being leaked. Further, when the task management DB 10 associates a customer ID with the distribution destination telephone number and stores them, a query character string including the customer ID can be employed. In this case, the message distribution server 2 can set the latest distribution request among a plurality of distribution requests corresponding to the customer ID as the distribution request specified by the query character string.

The distribution message generation unit 18 generates a distribution message to be distributed to the mobile terminal 4 by means of an SMS. The distribution message includes at least a translation. In this example embodiment, the distribution message may include the above URL character string in addition to the translation. The distribution message generation unit 18 writes the generated distribution message in the “distribution message” of the task management DB 10 shown in FIG. 4.

The distribution unit 19 distributes the distribution message generated by the distribution message generation unit 18 to the mobile terminal 4 corresponding to the distribution destination telephone number by means of an SMS through the telephone network.

The retranslation reception unit 20 receives a retranslation request from the mobile terminal 4 that has accessed the message distribution server 2 using the URL character string included in the distribution message. The retranslation request includes a designated translation language. The designated translation language is the translation language designated by a user of the mobile terminal 4. The retranslation reception unit 20 acquires a query character string included in the URL character string used by the mobile terminal 4 to access the message distribution server 2, and specifies a distribution request associated with a user of the mobile terminal 4 based on the acquired query character string.

The retranslation reception unit 20 further associates the designated translation language included in the retranslation request with the distribution destination telephone number corresponding to the distribution request specified by the above query character string and registers them in the designated translation language DB 11.

The retranslation unit 21 translates the reception message body or the translation corresponding to the distribution request specified by the query character string into the designated translation language. Specifically, the retranslation unit 21 translates the reception message body written in the “reception message” of the task management DB 10 shown in FIG. 4 or the translation written in the “translation” of the task management DB 10 into the designated translation language. The translation generated at this time is hereinafter referred to as a designated translation. The designated translation is a specific example of a second translation message body. Note that the retranslation unit 21 typically translates the reception message body written in the “reception message” of the task management DB 10 shown in FIG. 4 into the designated translation language in order to reduce variations in nuances due to translation.

The provision unit 22 provides the designated translation to the mobile terminal 4. At this time, the provision unit 22 may transmit the designated translation to the mobile terminal 4 by means of an SMS though the telephone network or may transmit the designated translation to the mobile terminal 4 via the Internet.

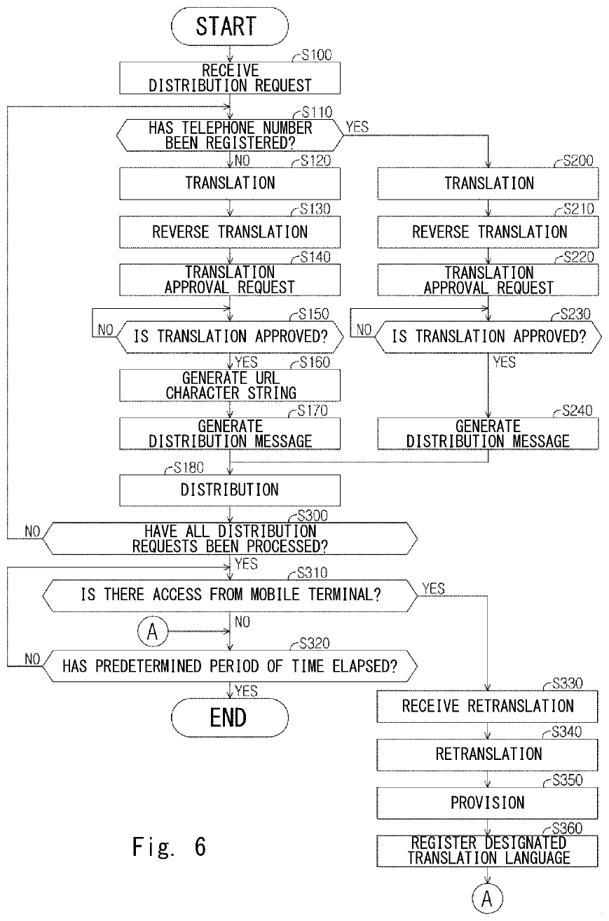

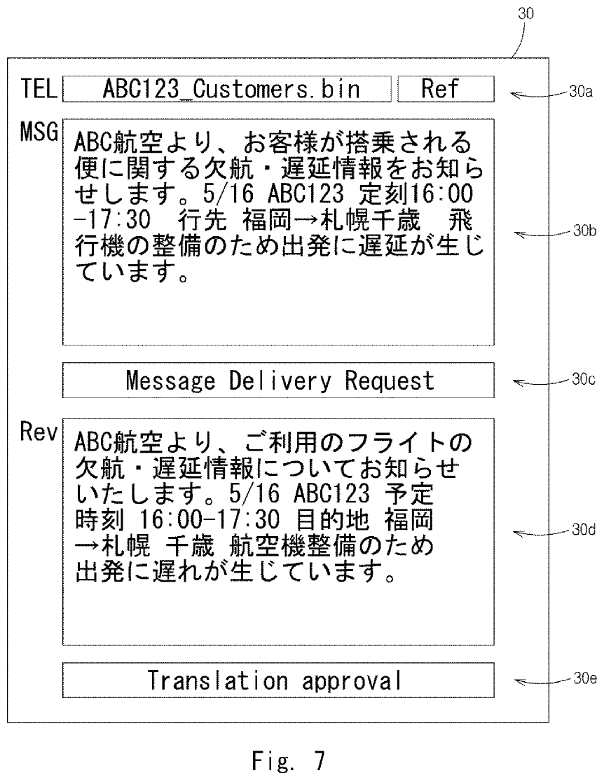

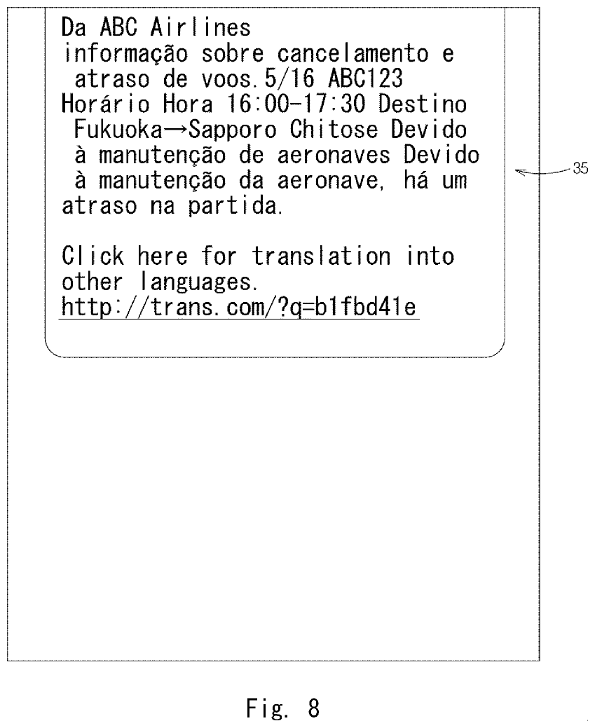

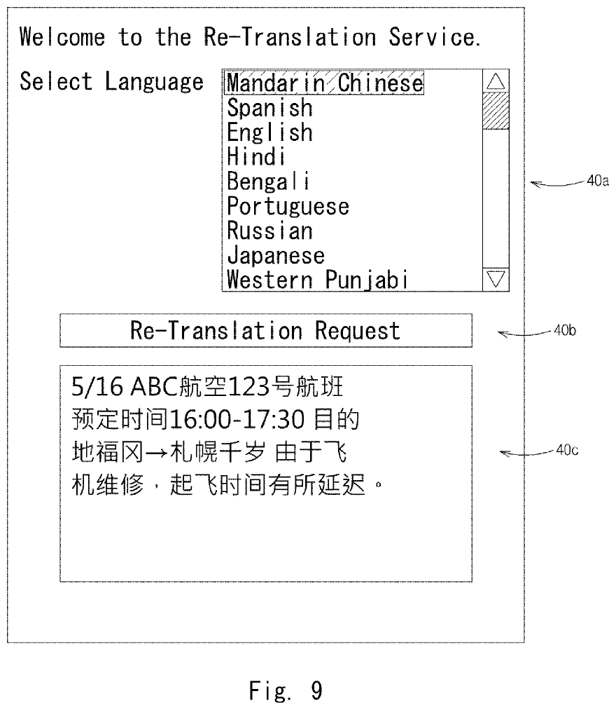

Next, operations performed by the message distribution server 2 will be described with reference to FIGS. 6 to 9. FIG. 6 is a control flow of the message distribution server 2. FIG. 7 shows a distribution request screen displayed on a display of the business entity terminal 3. FIG. 8 shows a distribution message distributed to the mobile terminal 4 by means of an SMS. FIG. 9 shows a retranslation request screen displayed on a display of the mobile terminal 4.

In the following description, it is assumed that the business entity that owns the business entity terminal 3 distributes messages having the same contents to 300 service users. Further, it is assumed that the business entity prepares only messages in Japanese. S100:

As shown in FIG. 7, when the business entity terminal 3 accesses the message distribution server 2, a distribution request screen 30 is displayed on the display of the business entity terminal 3. The distribution request screen 30 includes a selection part 30a for selecting a distribution destination file including telephone numbers of all service users of the distribution destination, a message input part 30b for inputting a message to be distributed, and an execution part 30c for executing a distribution request to the message distribution server 2. The distribution request screen 30 includes a reverse translation display part 30d for displaying a reverse translation, and a translation approval part 30e for inputting a translation approval.

An operator of the business entity terminal 3 selects a distribution destination file from the selection part 30a. Next, the operator of the business entity terminal 3 inputs a reception message body to be distributed to the message input part 30b. In this example embodiment, the operator of the business entity terminal 3 inputs a Japanese reception message body to the message input part 30b. When the operator of the business entity terminal 3 has completed the above selection and input operation, the operator of the business entity terminal 3 operates the execution part 30c. Then the business entity terminal 3 executes a distribution request to the message distribution server 2. That is, the business entity terminal 3 transmits a distribution request including the distribution destination telephone number and the reception message body to the message distribution server 2 for each telephone number included in the distribution destination file. Therefore, when the distribution destination file includes 300 telephone numbers, the business entity terminal 3 transmits the distribution request to the message distribution server 2 300 times. However, the business entity terminal 3 may instead organize a plurality of distribution requests into one distribution request file and transmit this distribution request file to the message distribution server 2.

The distribution request reception unit 12 of the message distribution server 2 simultaneously receives a plurality of distribution requests from the business entity terminal 3. The distribution request reception unit 12 registers a plurality of distribution requests received from the business entity terminal 3 in the task management DB 10. Specifically, as shown in FIG. 4, the distribution request reception unit 12 writes the distribution destination telephone number of the distribution request in the “distribution destination telephone number” of the task management DB 10, extracts the country code from the distribution destination telephone number, writes it in the “country code” of the task management DB 10, and writes the reception message body in the “reception message” of the task management DB 10. Further, the distribution request reception unit 12 generates a hash value of the distribution request identification number and writes it in the “hash value” of the task management DB 10. In the following description, the message distribution server 2 executes the processes from Step S110 to Step S240 for each distribution request.

### S110:

First, the translation unit 13 of the message distribution server 2 determines whether the distribution destination telephone number included in the distribution request has been registered in the designated translation language DB 11. When the distribution destination telephone number has not been registered in the designated translation language DB 11, the translation unit 13 advances the process to Step S120. When the distribution destination telephone number has been registered in the designated translation language DB 11, the translation unit 13 advances the process to Step S200.

### S120:

Next, the translation unit 13 of the message distribution server 2 translates the reception message body of the distribution request into a language corresponding to the country code. Specifically, the translation unit 13 translates the reception message body written in the “reception message” of the task management DB 10 shown in FIG. 4 in a language uniquely defined based on the corresponding country code, and writes this translation in the “translation” of the task management DB 10.

### S130:

Next, the reverse translation unit 14 of the message distribution server 2 reverse-translates the translation generated by the translation unit 13 into the language of the reception message body. Specifically, the reverse translation unit 14 translates the translation written in the “translation” of the task management DB 10 shown in FIG. 4 in the language of the reception message body, and writes the reverse translation, which is the resultant translation, in the “reverse translation” of the task management DB 10.

### S140:

Next, the translation approval request unit 15 of the message distribution server 2 transmits the reverse translation and a translation approval request to the business entity terminal 3, which is the distribution request source, so that the distribution request source can confirm the validity of the translation by the translation unit 13. Then, as shown in FIG. 7, the reverse translation is displayed on the reverse translation display part 30d of the distribution request screen 30. An operator of the business entity terminal 3 compares the reception message body of the message input part 30b with the reverse translation of the reverse translation display part 30d, and evaluates the validity of the translation by the message distribution server 2. When the operator of the business entity terminal 3 determines that there is no problem with the translation by the message distribution server 2, the operator of the business entity terminal 3 operates the translation approval part 30e. By doing the above, the business entity terminal 3 transmits a translation approval to the message distribution server 2.

### S150:

Next, the translation approval reception unit 16 of the message distribution server 2 waits until it receives the translation approval from the business entity terminal 3, which is the distribution request source, and when the translation approval reception unit 16 of the message distribution server 2 receives the translation approval, it advances the process to Step S160.

### S160:

Next, the URL character string generation unit 17 of the message distribution server 2 generates a URL character string for accessing the message distribution server 2 when a user of the mobile terminal 4 cannot understand the message distributed by means of an SMS. The URL character string generation unit 17 writes the generated URL character string in the “URL” of the task management DB 10 shown in FIG. 4.

### S170:

Next, the distribution message generation unit 18 of the message distribution server 2 generates a distribution message to be distributed to the mobile terminal 4 by means of an SMS. The distribution message includes a translation and a URL character string. The distribution message preferably includes a guidance message indicating that the distribution message is retranslated into another language upon accessing the URL indicated by the URL character string. The guidance message is typically prepared in English (see also FIG. 8). The distribution message generation unit 18 writes the generated distribution message in the “distribution message” of the task management DB 10 shown in FIG. 4.

### S180:

Next, the distribution unit 19 of the message distribution server 2 distributes the distribution message generated by the distribution message generation unit 18 to the mobile terminal 4 corresponding to the distribution destination telephone number by means of an SMS through the telephone network. Then, as shown in FIG. 8, a distribution message 35 distributed by means of an SMS is displayed, for example, in a pop-up form on the display of the mobile terminal 4.

### S300:

The message distribution server 2 determines whether all the distribution requests registered in the task management DB 10 have been processed, returns the process to Step S110 when there are still unprocessed distribution requests, and advances the process to Step S310 when all the distribution requests have been processed.

### S200-S240:

A series of information processes from Step S200 to Step S240 is branched from Step S110 and returns to Step S180.

### S200:

When the distribution destination telephone number has been registered in the designated translation language DB 11 in S110, the translation unit 13 refers to the designated translation language DB 11 and acquires the designated translation language corresponding to the distribution destination telephone number. Then the translation unit 13 translates the reception message body written in the “reception message” of the task management DB 10 shown in FIG. 4 into the designated translation language. The translation unit 13 writes this translation in the “translation” of the task management DB 10.

### S210:

Next, the reverse translation unit 14 of the message distribution server 2 reverse-translates the translation generated by the translation unit 13 into the language of the reception message body. Specifically, the reverse translation unit 14 translates the translation written in the “translation” of the task management DB 10 shown in FIG. 4 in the language of the reception message body, and writes the reverse translation, which is the resultant translation, in the “reverse translation” of the task management DB 10.

### S220:

Next, the translation approval request unit 15 of the message distribution server 2 transmits the reverse translation and a translation approval request to the business entity terminal 3, which is the distribution request source, so that the distribution request source can confirm the validity of the translation by the translation unit 13. Then, as shown in FIG. 7, the reverse translation is displayed on the reverse translation display part 30d of the distribution request screen 30. An operator of the business entity terminal 3 compares the reception message body of the message input part 30b with the reverse translation of the reverse translation display part 30d, and evaluates the validity of the translation by the message distribution server 2. When the operator of the business entity terminal 3 determines that there is no problem with the translation by the message distribution server 2, the operator of the business entity terminal 3 operates the translation approval part 30e. By doing the above, the business entity terminal 3 transmits a translation approval to the message distribution server 2.

### S230:

Next, the translation approval reception unit 16 of the message distribution server 2 waits until it receives the translation approval from the business entity terminal 3, which is the distribution request source, and when the translation approval reception unit 16 of the message distribution server 2 receives the translation approval, it advances the process to Step S240.

### S240:

Next, the distribution message generation unit 18 of the message distribution server 2 generates a distribution message to be distributed to the mobile terminal 4 by means of an SMS. The distribution message includes a translation. The distribution message does not include the above-described URL character string. The distribution message generation unit 18 writes the generated distribution message in the “distribution message” of the task management DB 10 shown in FIG. 4. Then the distribution message generation unit 18 of the message distribution server 2 returns the process to Step S180.

### S310:

As shown in FIG. 8, a user, who has received the distribution message distributed to the mobile terminal 4 by means of an SMS, checks the distribution message and obtains necessary information for the user. When the distribution message is written in a language other than the language that the user can understand, the user taps the URL character string included in the distribution message. Then the mobile terminal 4 accesses the message distribution server 2.

After the message distribution server 2 has processed all the distribution requests, the message distribution server 2 determines whether there is access from the mobile terminal 4. When there is access from the mobile terminal 4, the message distribution server 2 acquires a query character string from the URL character string used for the access to the message distribution server 2 by the mobile terminal 4, and advances the process to Step S330. On the other hand, when there is no access from the mobile terminal 4, the message distribution server 2 advances the process to Step S320.

### S320:

The message distribution server 2 determines whether a predetermined period of time has elapsed since it has received the distribution request in Step S100. When the message distribution server 2 determines that the predetermined period of time has elapsed, the message distribution server 2 terminates the process. When the message distribution server 2 determines that the predetermined period of time has not elapsed, the process returns to Step S310, and waits for access from the mobile terminal 4. The predetermined period of time is, for example, 72 hours.

### S330:

Next, the retranslation reception unit 20 of the message distribution server 2 transmits a retranslation request screen to the mobile terminal 4. FIG. 9 shows a retranslation request screen 40 displayed on the display of the mobile terminal 4. As shown in FIG. 9, the retranslation request screen 40 includes a language selection part 40a for selecting a designated translation language which is a language that can be understood by a user, a retranslation request part 40b, and a retranslation display part 40c for displaying a retranslation.

A user of the mobile terminal 4 selects a language that can be understood by the user in the language selection part 40a. In the example shown in FIG. 9, the user of the mobile terminal 4 has selected Mandarin Chinese. After that, the user of the mobile terminal 4 operates the retranslation request part 40b. Then the mobile terminal 4 transmits a retranslation request including the designated translation language to the message distribution server 2.

The retranslation reception unit 20 of the message distribution server 2 receives the retranslation request from the mobile terminal 4. The retranslation reception unit 20 specifies a distribution request associated with the user of the mobile terminal 4 from a plurality of distribution requests registered in the task management DB 10 based on the query character string acquired from the URL character string used by the mobile terminal 4 to access the message distribution server 2.

### S340:

Next, the retranslation unit 21 of the message distribution server 2 translates the reception message body or the translation corresponding to the distribution request specified by the query character string into the designated translation language, to thereby generate a designated translation.

### S350:

Next, the provision unit 22 of the message distribution server 2 transmits the designated translation to the mobile terminal 4 via the Internet. Then, as shown in FIG. 9, the above designated translation is displayed on the retranslation display part 40c of the retranslation request screen 40. In this way, the user of the mobile terminal 4 can accurately understand the message distributed from the business entity terminal 3.

### S360:

Next, the retranslation reception unit 20 of the message distribution server 2 associates the designated translation language included in the retranslation request with the distribution destination telephone number corresponding to the above query character string and registers them in the designated translation language DB 11, and returns the process to Step S320. By doing so, the message distribution server 2 does not transmit the distribution message described in a language other than the language that can be understood by the user of the mobile terminal 4 to the mobile terminal 4 twice (Step S110, Step S200). Further, the message distribution server 2 does not include the URL character string in the subsequent distribution messages to be distributed by means of an SMS to the mobile terminal 4 after the telephone number of the mobile terminal 4 has been registered in the designated translation language DB 11. Therefore, it is possible to avoid repeatedly giving a user a peculiar feeling of anxiousness that the URL string may cause a disadvantage to the user when the user receives a short message including the URL character string.

The second example embodiment has been described above. The above second example embodiment has the following features.

As shown in FIG. 3, the message distribution server 2 (the message distribution system) includes the distribution request reception unit 12, the translation unit 13, the distribution message generation unit 18, and the distribution unit 19. The distribution request reception unit 12 receives a distribution request including a reception message body and a distribution destination telephone number including a country code. The translation unit 13 translates the reception message body into a language corresponding to the country code, to thereby generate a translation (a first translation message body). The reverse translation unit 14 generates a distribution message including the translation. The distribution unit 19 distributes the distribution message to the mobile terminal 4 corresponding to the distribution destination telephone number by means of an SMS. According to the above configuration, it is possible to translate a message into a suitable language and then distribute it by means of an SMS. Specifically, since it is not necessary to know the language used for each user, a message can be quickly distributed to a plurality of users who use languages different from each other.

In the above example embodiment, the business entity terminal 3 is provided in an aviation business entity. Alternatively, however, the business entity terminal 3 may be provided in an automobile manufacturing entity. By using the message distribution server 2, an automobile manufacturing entity can quickly and accurately distribute messages such as recall information. The business entity terminal 3 may be provided in a tourist business entity. By using the message distribution server 2, the tourist business entity can quickly and accurately distribute messages such as earthquake information and evacuation information to inbound tourists.

Further, the distribution message generation unit 18 generates a distribution message including a translation and a URL character string for accessing the message distribution server 2. The URL character string includes a query character string for specifying a distribution request. The message distribution server 2 includes the retranslation reception unit 20, the retranslation unit 21, and the provision unit 22. The retranslation reception unit 20 receives a retranslation request including a designated translation language from the mobile terminal 4. The retranslation unit 21 translates the reception message body or the above translation corresponding to the distribution request specified by the query character string into the designated translation language, to thereby generate a designated translation (a second translation message body). The provision unit 22 provides the designated translation to the mobile terminal 4. According to the above configuration, when a language that can be understood by a user differs from a language corresponding to the country code registered in the SIM card of the mobile terminal 4 carried by the user, a message translated in a language that can be understood by the user can be distributed to the user.

Further, the message distribution server 2 further includes the designated translation language DB 11 (the designated translation language storage unit) that associates a designated translation language with a distribution destination telephone number and stores them. The retranslation reception unit 20 associates the designated translation language with the distribution destination telephone number corresponding to the query character string and registers them in the designated translation language storage unit.

Further, when the distribution destination telephone number has been registered in the designated translation language DB 11, the translation unit 13 translates the reception message body into the designated translation language corresponding to the distribution destination telephone number, to thereby generate a translation. According to the above configuration, since the message translated into a language that cannot be understood by a user is not distributed to the user twice, the user can obtain information indicated by a message distributed by the business entity terminal 3 more quickly.

Further, when the translation unit 13 translates the reception message body into the designated translation language corresponding to the distribution destination telephone number, to thereby generate a translation, a distribution message does not include the URL character string. According to the above configuration, it is possible to avoid repeatedly giving a user a peculiar feeling of anxiousness that the URL string may cause a disadvantage to the user when the user receives a short message including the URL character string.

The message distribution server 2 further includes the reverse translation unit 14, the translation approval request unit 15, and the translation approval reception unit 16. The reverse translation unit 14 reverse-translates the translation into the language of the reception message body, to thereby generate a reverse translation (a third translation message body). The translation approval request unit 15 transmits the reverse translation and a translation approval request to the distribution request source. The translation approval reception unit 16 receives a translation approval from the distribution request source. When the translation approval reception unit 16 receives the translation approval, the distribution unit 19 distributes the distribution message to the mobile terminal 4 corresponding to the distribution destination telephone number by means of an SMS. According to the above configuration, it is possible to prevent a translation translated inappropriately from being distributed by means of an SMS.

Note that the message distribution server 2 according to the second example embodiment may be implemented by distributed processing in which a server that manages distribution requests, a server that executes translation, and a server that receives retranslation requests are combined.

Although the present invention has been described as a hardware configuration in the above example embodiments, the present invention is not limited thereto. In the present invention, any processing can also be implemented by causing a Central Processing Unit (CPU) to execute a computer program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### REFERENCE SIGNS LIST

1 DISTRIBUTION SYSTEM
2 MESSAGE DISTRIBUTION SERVER
3 BUSINESS ENTITY TERMINAL
4 MOBILE TERMINAL
10 TASK MANAGEMENT DB
11 DESIGNATED TRANSLATION LANGUAGE DB
12 DISTRIBUTION REQUEST RECEPTION UNIT
13 TRANSLATION UNIT
14 REVERSE TRANSLATION UNIT
15 TRANSLATION APPROVAL REQUEST UNIT
16 TRANSLATION APPROVAL RECEPTION UNIT
17 URL CHARACTER STRING GENERATION UNIT
18 DISTRIBUTION MESSAGE GENERATION UNIT
19 DISTRIBUTION UNIT
20 RETRANSLATION RECEPTION UNIT
21 RETRANSLATION UNIT
22 PROVISION UNIT
30 DISTRIBUTION REQUEST SCREEN
30a SELECTION PART
30b MESSAGE INPUT PART
30c EXECUTION PART
30d REVERSE TRANSLATION DISPLAY PART
30e TRANSLATION APPROVAL PART
35 DISTRIBUTION MESSAGE
40 RETRANSLATION REQUEST SCREEN
40a LANGUAGE SELECTION PART
40b RETRANSLATION REQUEST PART
40c RETRANSLATION DISPLAY PART
100 MESSAGE DISTRIBUTION SYSTEM
10 DISTRIBUTION REQUEST RECEPTION UNIT
102 TRANSLATION UNIT
103 DISTRIBUTION MESSAGE GENERATION UNIT
104 DISTRIBUTION UNIT

What is claimed is:

1. A message distribution system comprising:
at least one memory storing instructions; and
at least one processor configured to execute the instructions to:
receive a distribution request including a reception message body and a distribution destination telephone number including a country code;
translate the reception message body into a language corresponding to the country code, to thereby generate a first translation message body;
generate a distribution message including the first translation message body; and
distribute the distribution message to a mobile terminal corresponding to the distribution destination telephone number by means of an SMS.

2. The message distribution system according to claim 1, wherein the at least one processor is further configured to execute the instructions to generate a distribution message including the first translation message body and a URL character string for accessing the message distribution system, wherein
the URL character string includes a query character string for specifying the distribution request, and
the at least one processor is further configured to execute the instructions to:
receive a retranslation request including a designated translation language from the mobile terminal;
translate the reception message body or the first translation message body corresponding to the distribution request specified by the query character string into the designated translation language, to thereby generate a second translation message body; and
provide the second translation message body to the mobile terminal.

3. The message distribution system according to claim 2, wherein the at least one processor is further configured to execute the instructions to: associate the designated translation language with the distribution destination telephone number and store them; and
associate the designated translation language with the distribution destination telephone number corresponding to the query character string and registers them in the at least one memory.

4. The message distribution system according to claim 3, wherein when the distribution destination telephone number has been registered in the at least one memory, the at least one processor is further configured to execute the instructions to translate the reception message body into the designated translation language corresponding to the distribution destination telephone number, to thereby generate the first translation message body.

5. The message distribution system according to claim 4, wherein when the at least one processor is further configured to execute the instructions to translate the reception message body into the designated translation language corresponding to the distribution destination telephone number, to thereby generate the first translation message body, the distribution message does not include the URL character string.

6. The message distribution system according to claim 1, wherein the at least one processor is further configured to execute the instructions to:
reverse-translate the first translation message body into a language of the reception message body, to thereby generate a third translation message body;
transmit the third translation message body and a translation approval request to a distribution request source;
receive a translation approval from the distribution request source; and
distribute the distribution message to the mobile terminal corresponding to the distribution destination telephone number by means of an SMS when receiving the translation approval.

7. A message distribution method comprising:
a distribution request reception step of receiving a distribution request including a reception message body and a distribution destination telephone number including a country code;
a translation step of translating the reception message body into a language corresponding to the country code, to thereby generate a first translation message body;
a distribution message generation step of generating a distribution message including the first translation message body; and
a distribution step of distributing the distribution message to a mobile terminal corresponding to the distribution destination telephone number by means of an SMS.

8. A non-transitory computer readable medium storing a program for causing a computer to execute:
a distribution request reception step of receiving a distribution request including a reception message body and a distribution destination telephone number including a country code;
a translation step of translating the reception message body into a language corresponding to the country code, to thereby generate a first translation message body;
a distribution message generation step of generating a distribution message including the first translation message body; and
a distribution step of distributing the distribution message to a mobile terminal corresponding to the distribution destination telephone number by means of an SMS.
